(19) United States
(12) Patent Application Publication
(10) Pub. No.: US 2008/0040865 A1
(43) Pub. Date: Feb. 21, 2008

(54) Fluorescent Whitening Pigments

(76) Inventors: Ted Deisenroth, Brookfield, CT (US); Kamalesh Pai Fondekar, Thane (IN); Peter Rohringer, Schonenbuch (CH); Fabienne Cuesta, Waldighoffen (FR); Ramachandra V. Joshi, Thane (IN); Smita G. Kavishwar, Mumbai (IN); Uma Shadakshari, Navi Mumbai (IN)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/579,490

(22) PCT Filed: Nov. 8, 2004
(86) PCT No.: PCT/EP04/52869

§ 371 Date: Feb. 8, 2007

(30) Foreign Application Priority Data
Nov. 18, 2003 (EP) 03104242.7

(51) Int. Cl. C08G 12/32; C08G 12/38; C09B 69/10; D21H 17/49

(52) U.S. Cl. 8/110; 106/287.2

(57) ABSTRACT

A whitening pigment comprising the reaction product of (a) a melamine-formaldehyde and/or a melamine-urea poly-condensation product and (b) a water-soluble fluorescent whitening agent of the formula (1), wherein each of the two R₁ groups, independent of the other, represents a C₁-C₆alkyl or C₁-C₄alkyl-O—C₁-C₄alkyl residue, which is substituted by one or two —CONH₂, —CONHC₁-C₄alkyl, —COOH, —SO₂NH₂, —SO₂NHC₁-C₄alkyl or —NH₂ groups, each of the two R₂ groups, independent of the other, represents hydrogen, C₁-C₄alkyl, C₂-C₄hydroxyalkyl or C₁-C₄alkoxyC₁-C₄alkyl, or R₁ and R₂ together with the nitrogen atom complete a piperazine ring, each of the two X₁ groups, independently, represent —OH, —OC₁-C₄alkyl, —Oaryl or the group —NR₃R₄, wherein R₃ and R₄ each, independently, represent hydrogen, C₁-C₄alkyl, C₂-C₄hydroxyalky, C₁-C₄alkoxyC₁-C₄alkyl, a phenyl, phenyl mono- or disulphonic acid residue or, R₃ and R₄, together with the nitrogen atom to which they are attached, complete a morpholino, piperidino or pyrrolidino ring or, alternatively, X₁ represents an amino acid residue from which a hydrogen atom has been abstracted from the amino group and M is hydrogen, an alkaline or alkaline earth metal ion, ammonium, mono- di-, tri- or tetra-substituted C₁-C₄alkylammonium or C₂-C₄hydroxyalkylammonium or mixtures thereof, a process for preparation of the pigments and the use thereof for the fluorescent whitening of paper.

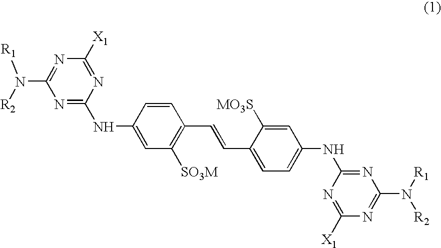

The present invention relates to novel whitening pigments obtained by reaction of a melamine-formaldehyde and/or melamine-urea polycondensate with a water soluble fluorescent whitening agent containing polymerisable groups, a process for preparation of the whitening pigments and their use for the fluorescent whitening of paper, especially in coating.

Aqueous coating compositions are used extensively in the production of coated papers and cardboards. For the purpose of whitening, the coating compositions generally comprise anionic fluorescent whitening agents, the action of which is highly dependent on the amount and nature of co-binders used. The use of such anionic fluorescent whitening agents in cationic coating compositions, for example for ink-jet papers, results in a loss of primary effect and poor fastness to light. Bleeding can also be a problem for water-soluble fluorescent whitening agents, particularly in paper and board intended for use in food packaging.

One approach to solving such problems has been disclosed in WO 01/11140 A1, whereby mechanical mixtures of melamine-formaldehyde or phenol-formaldehyde polycondensation products together with water-soluble fluorescent whitening agents are used as whitening pigments for coating compositions. However, such mixtures suffer from the disadvantage that only minor quantities of fluorescent whitening agents are incorporated into large amounts of the polycondensate, thus leading to difficulties in dosage and resulting in large quantities of the polycondensate being present in the coating composition, which may be undesirable.

Surprisingly, it has now been found that coating compositions possessing superior properties, especially with regard to light fastness, result by the incorporation of a whitening pigment resulting from reaction of a melamine-formaldehyde and/or melamine-urea polycondensate with a water soluble fluorescent whitening agent containing polymerisable groups, since the fluorescent whitener is protected from environmental influences.

Accordingly, the present invention relates to a whitening pigment comprising the reaction product of

(a) a melamine-formaldehyde and/or a melamine-urea polycondensation product and
(b) a water-soluble fluorescent whitening agent of the formula

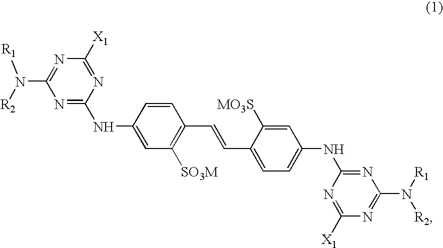

wherein each of the two

### R₁ groups, independent of the other, represents a C₁-C₆alkyl or C₁-C₄alkyl—O—C₁-C₄alkyl residue, which is substituted by one or two —CONH₂, —CONHC₁-C₄alkyl, —COOH, —SO₂NH₂, —SO₂NHC₁-C₄alkyl or —NH₂ groups, each of the two

### R₂ groups, independent of the other, represents hydrogen, C₁-C₄alkyl, C₂-C₄hydroxyalkyl or C₁-C₄alkoxyC₁-C₄alkyl, or

R₁ and R₂ together with the nitrogen atom complete a piperazine ring, each of the two X₁ groups, independently, represent —OH, —OC₁-C₄alkyl, —Oaryl or the group —NR₃R₄, wherein R₃ and R₄ each, independently, represent hydrogen, C₁-C₄alkyl, C₂-C₄hydroxyalky, C₁-C₄alkoxyC₁-C₄alkyl, a phenyl, phenyl mono- or disulphonic acid residue or, R₃ and R₄, together with the nitrogen atom to which they are attached, complete a morpholino, piperidino or pyrrolidino ring or, alternatively, X₁ represents an amino acid residue from which a hydrogen atom has been abstracted from the amino group and

### M is hydrogen, an alkaline or alkaline earth metal ion, ammonium, mono- di-, tri- or tetra-substituted C₁-C₄alkylammonium or C₂-C₄hydroxyalkylammonium or mixtures thereof.

Suitable whitening pigments may also be obtained by using mixtures of water-soluble fluorescent whitening agents of formula (1).

In one preferred aspect of the invention the component (a) is a melamine-formaldehyde polycondensation product.

Condensation products of melamine and formaldehyde, also referred to as melamine-formaldehyde (MF) resins, are aminoplastic resins.

The said condensation products are prepared by acid- or base-catalysed reaction of melamine in a methylolation reaction with aqueous formaldehyde solutions to form N-methylol compounds. On extending the reaction time or increasing the temperature, the methylol groups then react with further melamine, forming methylene bridges or—when methylol groups react with one another—methylol ether bridges.

The reaction is usually halted at the stage where preliminary condensation products, which are still soluble or meltable, are present, in order for fillers to be added if desired. To improve the solubility of those preliminary condensation products, some of the methylol groups still remaining may, in addition, be etherified.

Etherification of the N-methylol compounds may also be carried out, after azeotropically distilling off the water with alcohols or glycols, or by spray-drying, by etherifying the practically water-free methylol-melamines with lower alcohols or glycols, with the addition of acid or alkaline catalysts, neutralising after etherification and, where appropriate, distilling off the excess alcohol or glycol.

Most preferred resins are tri- or penta-methylolmelamines which may be etherified with, for example, methanol or methanol/diethylene glycol mixtures.

Preferred fluorescent whitening agents of formula (1) are those in which each of the two R₁ groups, each of the two R₂ groups and each of the two X₁ groups are the same.

The non-aromatic substituent R₁, which is capable of reacting with the melamine-formaldehyde or urea-formaldehyde resin is, preferably a C₁-C₄alkyl residue, which is substituted by one —CONH₂ or —CONHC₁-C₄alkyl group, or may be an amino acid residue, for example, a lysine residue, but the most preferred R₁ residue is of the formula —CH₂CH₂C(=O)NH₂.

The R₂ groups, preferably, represent hydrogen, C₁-C₄alkyl or C₂-C₄hydroxyalkyl, most preferably a hydroxyethyl or hydroxypropyl residue, especially 2-hydroxyethyl.

The residue X₁ preferably represents the group —NR₃R₄, wherein

### R₃ represents hydrogen, C₁-C₄alkyl, C₂-C₄hydroxyalky, C₁-C₄alkoxyC₁-C₄alkyl, a phenyl, phenyl mono- or disulphonic acid residue,

### R₄ represents hydrogen C₁-C₄alkyl or C₂-C₄hydroxyalkyl or,

### R₃ and R₄, together with the nitrogen atom to which they are attached, complete a morpholino ring or, alternatively,

X₁ represents an amino acid residue from which a hydrogen atom has been abstracted from the amino group, especially those amino acid residues X₁ which are derived from glycine, alanine, sarcosine, serine, cysteine, phenylalanine, tyrosine (4-hydroxyphenylalanine), diiodotyrosine, tryptophan (β-indolylalanine), histidine ((β-imidazolylalanine), α-aminobutyric acid, methionine, valine (α-aminoisovaleric acid), norvaline, leucine (α-aminoisocaproic acid), isoleucine (α-amino-β-methylvaleric acid), norleucine (α-amino-n-caproic acid), arginine, ornithine (α,δ-diaminovaleric acid), lysine (α,ε-diaminocaproic acid), aspartic acid (aminosuccinic acid), glutamic acid (α-aminoglutaric acid), threonine, hydroxyglutamic acid, iminodiacetic add or taurine, or a mixture or an optical isomer thereof, whereby sarcosine, taurine, iminodiacetic acid and aspartic acid residues are particularly preferred and, most especially, an aspartic acid or a sarcosine residue.

### Most especially preferred residues X₁ are those in which X₁ represents an anilino, anilino-4-sulphonic acid, anilino-2,5-disulphonic acid or a morpholino residue.

M, in the compound of formula (1), preferably, represents hydrogen, lithium, sodium, potassium, calcium or magnesium, especially, hydrogen, sodium or potassium and, in particular, sodium.

Within the scope of the definitions of the compounds of formula (1) C₁-C₆alkyl radicals are branched or unbranched and are, for example, methyl, ethyl, propyl, isopropyl, n-butyl, isobutyl, t-butyl, n-pentyl, methyl butyl, ethyl propyl, n-hexyl, methyl pentyl or ethyl butyl; they may be unsubstituted or substituted by halogen, for example fluorine, chlorine or bromine or by a carboxylic acid or ester residue.

C₁-C₄Alkoxy represents, for example, methoxy, ethoxy, n-propoxy, isopropoxy, isobutoxy or n-butoxy whilst C₂-C₄hydroxyalkyl may, for example, be 1- or 2-hydroxyethyl, 2- or 3-hydroxypropyl or hydroxybutyl. Aryl is preferably phenyl, which is unsubstituted or substituted by one or two C₁-C₄alkyl- or C₁-C₄alkoxy radicals or by halogen.

The whitening pigments of the invention may be prepared by addition of the compound of formula (1) to an excess of the melamine-formaldehyde and/or melamine-urea polycondensate in aqueous media under acidic conditions resulting from the addition of strong mineral acid, for example, concentrated hydrochloric acid. The mixture is then stirred, preferably at elevated temperature, for example, at between 50 and 90° C., preferably 65 to 75° C. until reaction is complete and, subsequently, basifying the reaction mixture with strong inorganic base, for example, an alkali metal hydroxide such as sodium hydroxide. The resulting aqueous suspension may be used directly in the coating colour or, preferably, is filtered, the resulting whitening pigment dried and then ground to a suitable particle size.

The whitening pigments used in accordance with the invention are preferably obtained by reaction of

(a) from 50 to 98% by weight, preferably from 70 to 97% by weight, of a melamine-formaldehyde and/or melamine-urea polycondensation product and
(b) from 2 to 50% by weight, preferably from 3 to 30% by weight, of a water-soluble fluorescent whitening agent of formula (1).

The water-soluble fluorescent whitening agents of formula (1) are known compounds or may be obtained by known methods.

The finely particulate whitened whitening pigments used for fluorescent whitening of paper, can, after dry-grinding, be incorporated in powder form directly in the paper coating composition, the particle size being from 0.05 to 40 μm, preferably from 0.3 to 10 μm and especially from 0.5 to 5 μm.

In most instances, however, it will probably be more convenient to disperse the finely particulate whitening pigments in an aqueous phase and to incorporate the resulting aqueous dispersion in the paper coating compositions.

The amount of whitening pigments for use according to the invention employed in the paper coating composition depends on the desired whitening effect; it is usually from 0.01 to 10, preferably, 0.05 to 5 parts by weight of the fluorescent pigment of the invention per 100 parts by weight of inorganic pigment present in the coating colour.

The paper coating compositions generally have a solids content of from 10 to 80% by weight, preferably from 40 to 70% by weight.

In addition to the whitening pigment for use according to the invention, the coating compositions generally comprise, per 100 parts of inorganic pigment (for example, calcium carbonate or clay)
(i) from 3 to 25 parts by weight of binder, of which optionally up to half consists of natural (i.e. non-synthetic) or synthetic co-binder (for example starch, casein, polyvinyl alcohol, CMC),
(ii) 0 to 1 part by weight of rheology modifier and
(iii) 0 to 2 parts by weight of wet-strength agent.

The whitening pigments according to the invention are excellently suitable for whitening the optionally pigmented coating compositions customarily used in the textile, paint, adhesives, plastics, wood and paper industries. Such coating compositions comprise, as binders (co-binders), plastics dispersions based on copolymers of butadiene and styrene, of naphthalene sulphonic acids and formaldehyde, of polyethylene and polypropylene oxides, of acrylonitrile, butadiene and styrene, of acrylic acid esters, of ethylene and vinyl chloride and of ethylene and vinyl acetate, or homopolymers, such as polyvinyl chloride, polyvinylidene chloride, polyethylene, polyvinyl acetate, polyvinyl alcohol, or polyurethane.

For the purpose of pigmenting the coating compositions there are generally employed aluminium silicates, such as China clay or kaolin, and also barium sulphate, satin white, titanium dioxide or calcium compounds for paper. These are described by way of example in J. P. Casey “Pulp and Paper; Chemistry and Chemical Technology”, 2nd Ed. Vol. III; p. 1648-1649 and in Mc Graw-Hill “Pulp and Paper Manufacture”, 2^{nd} Ed. Vol. II, p. 497 and in EP-A-0 003 568. Additionally, coloured shading pigments or dyes and further FWA's may be added to the coating compositions.

The whitening pigments according to the invention may be used especially for the coating of paper, more especially ink-jet and photographic paper, wood, foils, textiles, non-woven materials and suitable building materials. Special preference is given to use on paper and cardboard and on photographic and ink-jet papers.

Consequently, a further aspect of the invention is paper, which has treated with a whitening pigment composition or a coating composition as described above.

The coatings or coverings so obtained have, in addition to a high degree of fastness to light, an excellent degree of whiteness. Evenness, smoothness, volume and printability properties are also improved because the whitening pigments used in accordance with the invention remain in the paper matrix as additional filler and have a favourable effect on the printability of the paper. Furthermore, due to their excellent bleed-fastness, such coatings are eminently suitable for use in food packaging materials.

The following Examples illustrate the invention, without intending to be restrictive in nature; parts and percentages are by weight unless otherwise stated.

### A. Preparation of Whitening Pigments

### EXAMPLE 1

To a stirred solution of 252 g of a 59.7% aqueous pentamethylol-melamine (LYOFIX™ CHN) and 7.5 g of the compound of formula

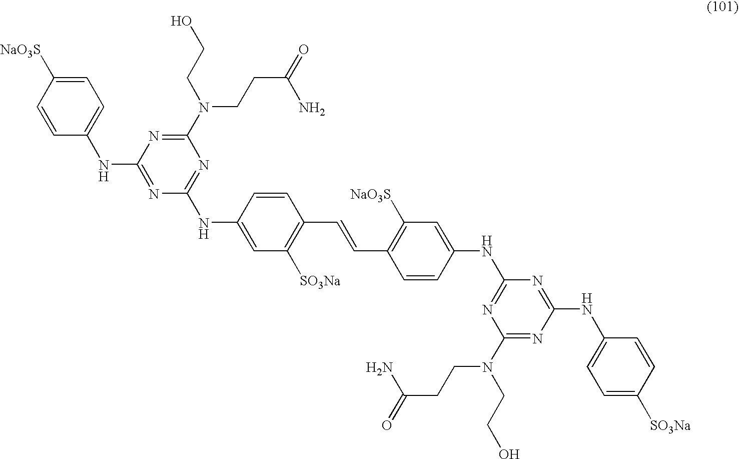

in 900 ml of water, 37% aqueous hydrochloric acid is added to adjust the pH to 3.9. The solution is heated to 70° C., the pH adjusted to 2.0 by the addition of further 37% aqueous hydrochloric acid and stirred at this temperature for 4 hours. After cooling to room temperature, the pH is adjusted to 9.5-10 by addition of 32% aqueous sodium hydroxide solution, the precipitated solids filtered, washed with water and dried under vacuum at 80° C. There are obtained 89 g of a white pigment incorporating 8% of the fluorescent whitening agent of formula (101).

### EXAMPLE 2

By reaction of 335 g of a 59.7% aqueous pentamethylol-melamine (LYOFIX™ CHN) with 5.0 g of the compound of formula (101), as described in Example 1, there are obtained 119 g of a white pigment incorporating 4% of the fluorescent whitening agent of formula (101).

### EXAMPLE 3

By reaction of 76.4 g of a 59.7% aqueous pentamethylol-melamine (LYOFIX™ CHN) with 4.58 g of the compound of formula (102)

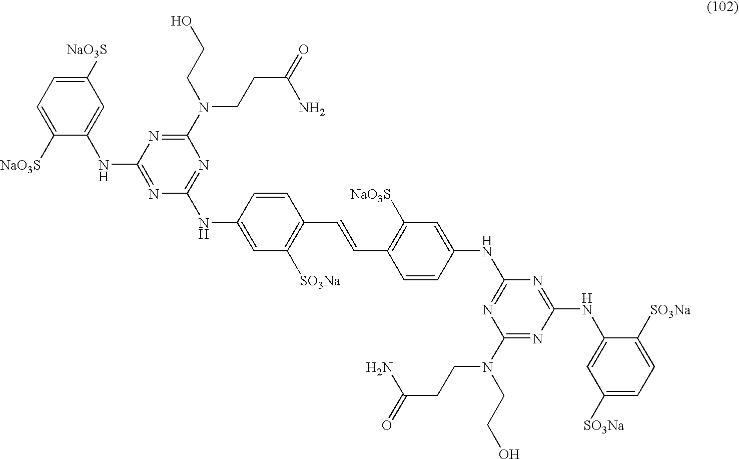

as described in Example 1, there are obtained 27.7 g of a white pigment incorporating 16% of the fluorescent whitening agent of formula (102).

### EXAMPLE 4

By reaction of 100 g of a 59.7% aqueous pentamethylol-melamine (LYOFIX™ CHN) with 11.9 g of the compound of formula (102), as described in Example 1, there are obtained 40.2 g of a white pigment incorporating 28% of the fluorescent whitening agent of formula (102).

### EXAMPLE 5

By reaction of 168 g of a 59.7% aqueous pentamethylol-melamine (LYOFIX™ CHN) with 7.0 g of the compound of formula (103)

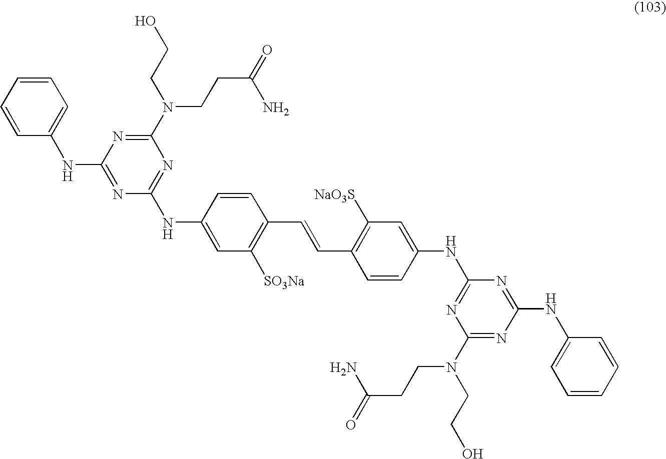

as described in Example 1, there are obtained 61 g of a white pigment incorporating 11% of the fluorescent whitening agent of formula (103).

### EXAMPLE 6

By reaction of 100 g of a 59.7% aqueous pentamethylol-melamine (LYOFIX™ CHN) with 3.0 g of the compound of formula (103), as described in Example 1, there are obtained 57 g of a white pigment incorporating 5% of the fluorescent whitening agent of formula (103).

### EXAMPLE 7

By reaction of 268.8 g of a 59.7% aqueous pentamethylol-melamine (LYOFIX™ CHN) with 32.0 g of the compound of formula (103), as described in Example 1, there are obtained 117 g of a white pigment incorporating 24% of the fluorescent whitening agent of formula (103).

### EXAMPLE 8

By reaction of 168 g of a 59.7% aqueous pentamethylol-melamine (LYOFIX™ CHN) with 10.0 g of the compound of formula (104)

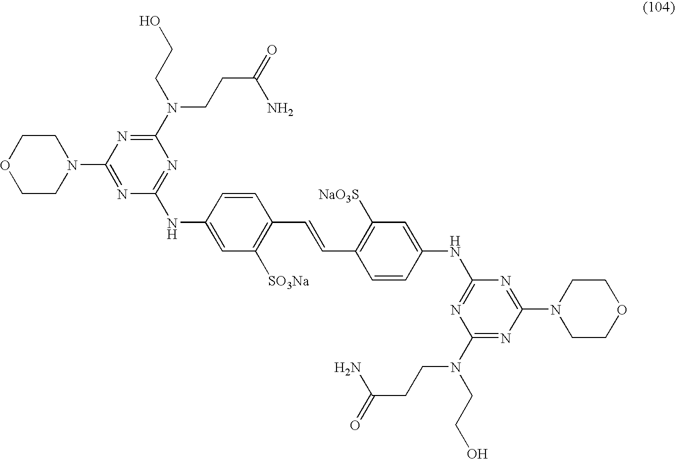

as described in Example 1, there are obtained 63.7 g of a white pigment incorporating 16% of the fluorescent whitening agent of formula (104).

### B. Application Examples

### 1). Preparation of Dispersions

6.0 g of each of the dried pigments, obtained as described in the above Examples 1-8, are added to 21.5 g of deionised water containing 2.5 g of dispersing agent (Pluronic™ F 108) and wet milled using 50 g of glass beads of 2 mm in diameter for a period of 15 hours. Following the milling process, the dispersions are separated from the glass beads by filtration through a coarse wire filter.

### 2). Preparation of Coating Mixture

To a coating colour having a solids content of 60% and consisting of 100 parts of a mixture of 60% calcium carbonate and 40% clay, 0.2 parts of polyvinyl alcohol and 9 parts of SBR binder followed by 4 parts of the whitening pigments obtained as described in Examples 1-8 and dispersed as described under Pt 1) above, based on the total weight of the coating pigment, are added. After stirring for 15 minutes to homogenize the coating colour, a base paper free of fluorescent whitening agent is coated using a laboratory drawdown coater with a coating speed of 5 m/min. such that a coat weight of approximately 28 g/m² results.

After drying, the ISO-fluorescence and CIE Whiteness values are measured by means of a Datacolor Elrepho 3000 spectrophotometer and the results are summarized in Table 1 below:

TABLE 1

| | Percentage | Pigment | | CIE |
|---|---|---|---|---|
| Example Nr. | FWA¹ | Example | Fluorescence | Whiteness |
| | None | | 0 | 75 |
| 9 | 8 | 1 | 10.9 | 110 |
| 10 | 4 | 2 | 8.3 | 103 |
| 11 | 16 | 3 | 13.1 | 114 |
| 12 | 28 | 4 | 13.8 | 115 |
| 13 | 11 | 5 | 11.9 | 112 |
| 14 | 5 | 6 | 8.1 | 102 |
| 15 | 24 | 7 | 14.0 | 115 |
| 16 | 16 | 8 | 12.6 | 114 |

¹Percentage of fluorescent whitening agent incorporated into whitener pigment of the respective Examples.

In a further series of experiments, coating compositions containing sufficient of the appropriate pigments of the invention to provide 0.075, 0.15 and 0.3 parts of the fluorescent whitening agents incorporated into the pigments, based on the total weight of inorganic pigment, were prepared and coated as described above.

The resulting ISO fluorescence and CIE Whiteness values are summarized in Table 2 below:

TABLE 2

| | | Pigment | | CIE |
|---|---|---|---|---|
| Example Nr. | Parts FWA¹ | Example | Fluorescence | Whiteness |
| | None | | 0 | 75 |
| 17 | 0.075 | 1 | 5.4 | 93 |
| 18 | 0.15 | 1 | 7.4 | 100 |
| 19 | 0.3 | 1 | 10.6 | 109 |
| 20 | 0.075 | 2 | 5.3 | 94 |
| 21 | 0.15 | 2 | 8.0 | 102 |
| 22 | 0.3 | 2 | 11.3 | 112 |
| 23 | 0.075 | 3 | 3.8 | 86 |
| 24 | 0.15 | 3 | 6.4 | 94 |
| 25 | 0.3 | 3 | 9.4 | 103 |
| 26 | 0.075 | 5 | 4.6 | 90 |
| 27 | 0.15 | 5 | 6.4 | 96 |
| 28 | 0.3 | 5 | 9.6 | 105 |

¹parts of the fluorescent whitening agents incorporated into the pigments, based on the total weight of inorganic pigment

The results summarized in the above Tables 1 and 2 clearly demonstrate both the excellent whitening effects of the fluorescent pigments of the invention and also their build-up characteristics, whereby no undesirable greening tendency is observed with increasing concentrations of fluorescent whitening agents.

1. A whitening pigment comprising the reaction product of
(a) a melamine-formaldehyde and/or a melamine-urea polycondensation product and
(b) a water-soluble fluorescent whitening agent of the formula 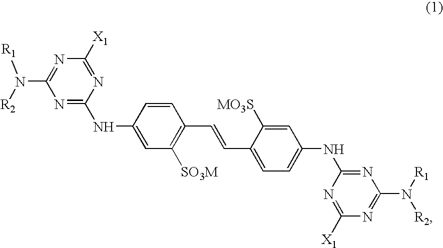
wherein each of the two
R₁ groups, independent of the other, represents a C₁-C₆alkyl or C₁-C₄alkyl-O—C₁-C₄alkyl residue, which is substituted by one or two —CONH₂, —CONHC₁-C₄alkyl, —COOH, —SO₂NH₂,
—SO₂NHC₁-C₄alkyl or —NH₂ groups, each of the two
R₂ groups, independent of the other, represents hydrogen, C₁-C₄alkyl, C₂-C₄hydroxyalkyl or C₁-C₄alkoxyC₁-C₄alkyl, or
R₁ and R₂ together with the nitrogen atom complete a piperazine ring, each of the two X₁ groups, independently, represent —OH, —OC₁-C₄alkyl, —Oaryl or the group —NR₃R₄, wherein R₃ and R₄ each, independently, represent hydrogen, C₁-C₄alkyl, C₂-C₄hydroxyalky,
C₁-C₄alkoxyC₁-C₄alkyl, a phenyl, phenyl mono- or disulphonic acid residue or,
R₃ and R₄, together with the nitrogen atom to which they are attached, complete a morpholino, piperidino or pyrrolidino ring or, alternatively,
X₁ represents an amino acid residue from which a hydrogen atom has been abstracted from the amino group and
M is hydrogen, an alkaline or alkaline earth metal ion, ammonium, mono- di-, tri- or tetra-substituted C₁-C₄alkylammonium or C₂-C₄hydroxyalkylammonium or mixtures thereof.

2. A whitening pigment according to claim 1, wherein the component
(a) is a melamine-formaldehyde polycondensation product.

3. A whitening pigment according to claim 1, wherein, in the compound of formula (1), each of the two R₁ groups, each of the two R₂ groups and each of the two X₁ groups are the same.

4. A whitening pigment according to claim 1, wherein, in the compound of formula (1),
R₁ represents a C₁-C₄alkyl residue which is substituted by one —CONH₂ or —CONHC₁-C₄alkyl group.

5. A whitening pigment according to claim 1, wherein, in the compound of formula (1),
R₂ represents hydrogen, C₁-C₄alkyl or C₂-C₄hydroxyalkyl.

6. A whitening pigment according to claim 1, wherein, in the compound of formula (1),
X₁ represents the group —NR₃R₄, wherein
R₃ represents hydrogen, C₁-C₄alkyl, C₂-C₄hydroxyalky, C₁-C₄alkoxyC₁-C₄alkyl, a phenyl, phenyl mono- or disulphonic acid residue,
R₄ represents hydrogen C₁-C₄alkyl or C₂-C₄hydroxyalkyl or,
R₃ and R₄, together with the nitrogen atom to which they are attached, complete a morpholino ring or, alternatively,
X₁ represents an amino acid residue from which a nitrogen atom has been abstracted from the amino group.

7. A whitening pigment according to claim 1, wherein, in the compound of formula (1),
M represents hydrogen, sodium or potassium.

8. A process for the preparation of whitening pigment according to claim 1, whereby a melamine-formaldehyde or melamine-urea polycondensation product is reacted with a fluorescent whitening agent of formula (1) in aqueous medium, in the presence of mineral acid, and subsequently treated with base.

9. A method for the fluorescent whitening of paper which comprises applying to paper an effective whitening amount of a whitening pigment according to claim 1.

10. A paper coating composition comprising, in addition to 0.01 to 10 parts by weight of the whitening pigment according to claim 1, per 100 parts of inorganic pigment,
(i) from 3 to 25 parts by weight of binder and co-binder,
(ii) 0 to 1 part by weight of rheology modifier and
(iii) 0 to 2 parts by weight of wet-strength agent.

11. A method for the fluorescent whitening of paper which comprises applying to paper an effective whitening amount of a paper coating composition according to claim 10.

12. Paper which has been treated with a whitening pigment composition according to claim 1.

13. Paper which has been treated with a coating composition according to claim 10.
